(19) United States
(12) Patent Application Publication
(10) Pub. No.: US 2005/0126686 A1
(43) Pub. Date: Jun. 16, 2005

(54) Combination back grind tape and underfill for flip chips

(76) Inventors: Yew Wee Cheong, Penang (MY); Marvin R. Diaz, Gen. Trias (PH); Cheong Huat Ng, Penang (MY)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/734,493

(22) Filed: Dec. 11, 2003

(51) Int. Cl. B32B 31/00; G05G 15/00

(52) U.S. Cl. 156/153; 156/349; 156/264

(57) ABSTRACT

The invention provides a material that acts as both back grind tape and underfill for flip chips. The material is applied to a wafer prior to back grinding, and remains in place during singulation and as the singulated flip chips are connected to substrates. This reduces process steps and provides more protection for the chip.

### BACKGROUND

Background of the Invention

Several semiconductor dice with microelectronic circuitry and devices are fabricated at once on a single wafer. Each die on the wafer may be, for example, a microprocessor. After the circuitry and devices have been fabricated on one side of the wafer, the wafer is thinned by grinding away the side of the wafer opposite the circuitry and devices. To protect the circuitry and devices, back grind tape is applied. After the wafer is thinned, this back grind tape is removed and discarded.

The wafer is then cut to separate the dice from each other. During this process, a die can be damaged. The singulated dice are connected to substrates by reflow soldering. Underfill material is then applied to the coupled die and substrate assemblies. The underfill material fills space between the die and substrate through capillary action. This underfill is then cured.

### BRIEF DESCRIPTION OF THE DRAWINGS

FIG. 1 is a flow chart that illustrates using a protective layer to protect dice on a wafer during thinning of the wafer and then act as underfill when a chip from that wafer is attached to a substrate.

FIG. 2 is a top view of a fabricated wafer.

FIG. 3a is a cross sectional side view of the wafer illustrating the application of the protective layer according to one embodiment of the present invention.

FIG. 3b is a magnified view of a portion of the cross sectional side view of the wafer of FIG. 3a.

FIG. 3c is a cross sectional side view of the wafer illustrating the application of the protective layer according to another embodiment.

FIG. 4 is a cross sectional side view of the wafer and protective layer.

FIGS. 5a and 5b are cross sectional side views illustrating the wafer before and after thinning.

FIG. 6a is a cross sectional side view of the wafer with the protective layer being cut to singulate the individual chips.

FIG. 6b is a cross sectional side view that illustrates one die after it has been singulated from the wafer.

FIG. 7 is a cross sectional side view of a die positioned adjacent to and being attached to a substrate while the protective layer is cured.

FIG. 8 is a schematic diagram of a computer system according to one embodiment of the present invention.

### DETAILED DESCRIPTION

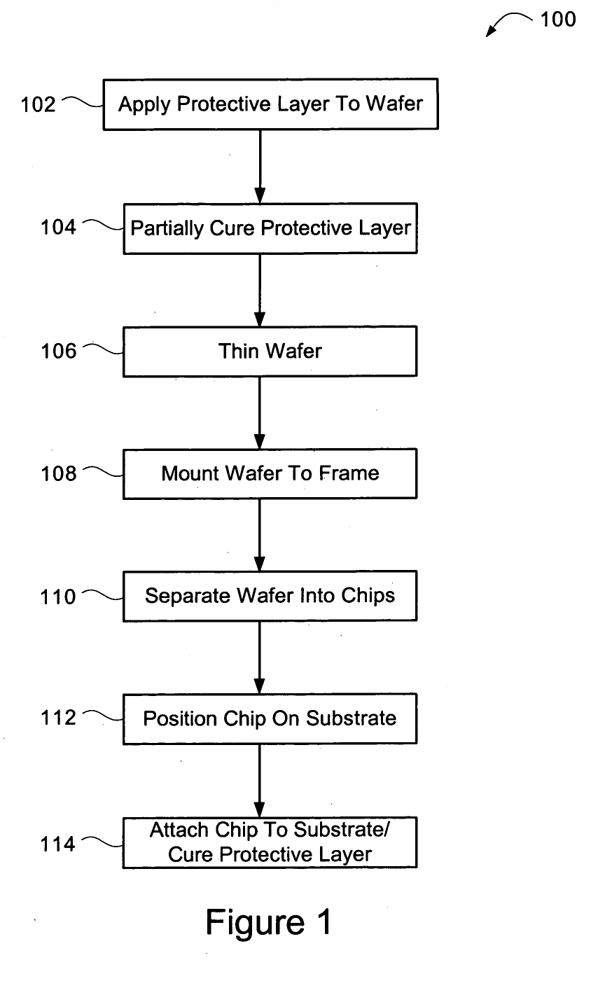

FIG. 1 is a flow chart 100 that illustrates using a protective layer to protect dice on a wafer during thinning of the wafer according to an embodiment of the present invention. In an embodiment, that protective layer may then act as underfill when a chip from that wafer is attached to a substrate. Note that the flow chart 100 of FIG. 1 merely represents one embodiment of the present invention. In other embodiments, some of the steps shown in the flow chart 100 may be omitted, other steps may be added, and/or the steps shown may be performed in a different order.

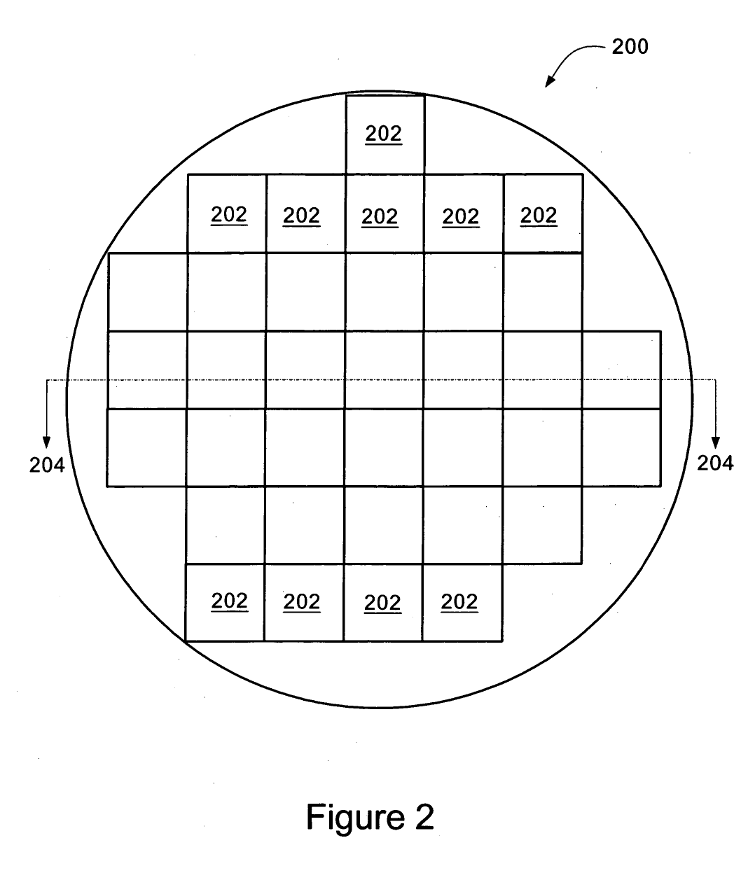

After one or more dice are fabricated on a wafer, a protective layer is applied 102 to the wafer. Referring now to FIG. 2, a top view of a fabricated wafer 200 is illustrated according to one embodiment of the present invention. During fabrication, a plurality of chips or dice 202 may have been formed on the wafer 200. The words “chip” and “die” are used interchangeably in this document. Each chip or die 202 may comprise microelectronic circuitry or devices. For example, each die 202 may comprise a microprocessor in an embodiment. In other embodiments, the protective layer 102 may be applied to a single chip 202 that is not connected to other chips 202 on a wafer.

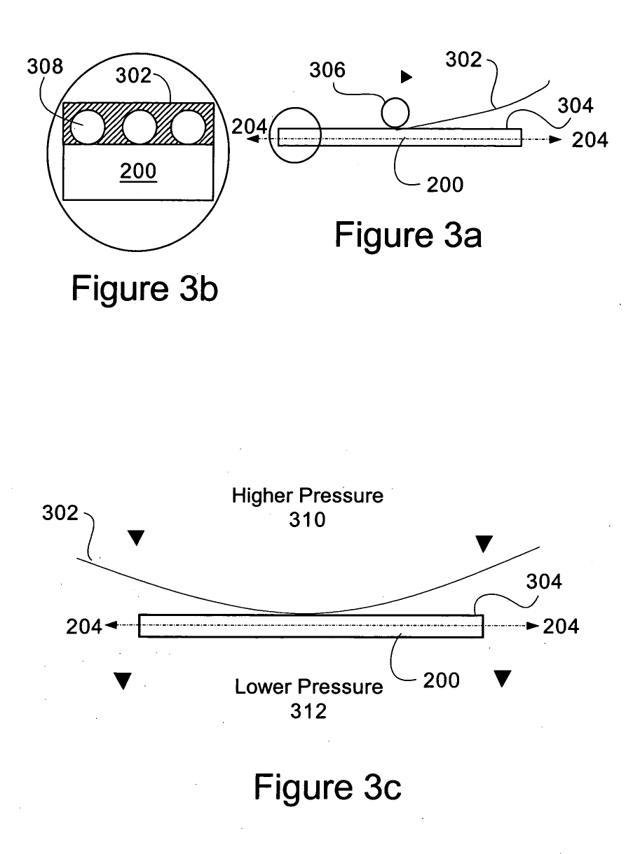

FIG. 3a is a cross sectional side view of the wafer 200 taken through reference line 204 of FIG. 2, and illustrates the application 102 of the protective layer 302 according to one embodiment. The protective layer 302 may comprise an epoxy film in one embodiment, or may comprise other materials in other embodiments. The protective layer 302 may be applied 102 through mechanical methods, such as by a mechanical roller 306 that may roll a smooth layer of the epoxy film onto the wafer 200. This protective layer 302 may be applied to the top side 304 of the wafer 200, which may be the side on which the microelectronic circuitry or devices of the chips 202 may be located.

FIG. 3b is a magnified view of a portion of the cross sectional side view of the wafer 200 of FIG. 3a that illustrates the wafer 200 after application of the protective layer 302 in more detail. There may be connection structures 308 coupled to the top side 304 of the wafer 200. These connection structures 308 may be solder balls in one embodiment, and may have been applied to the wafer 200 or chip 202 prior to application 102 of the protective layer 302. The protective layer 302 may be thick enough to cover the connection structures 308 extending above the wafer 200 as well as the wafer 200 itself. In one embodiment, the protective layer 302 is at least as high as the connection structures 308 so that the connection structures 308 are completely covered with material of the protective layer 302 after the layer 302 is applied. In an embodiment, the connection structures 308 comprise a eutectic bump with a height of about 3.5±0.9 thousandths of an inch, and the protective layer 302 has a thickness of at least that much. In another embodiment, the connection structures 308 comprise a copper column with a height of about 2±1 thousandths of an inch, and the protective layer 302 has a thickness of at least that much. In other embodiments, the connection structures 308 may comprise other structures with different heights, and the protective layer 302 may have corresponding thicknesses.

FIG. 3c is a cross sectional side view of the wafer 200 taken through reference line 204 of FIG. 2, and illustrates the application 102 of the protective layer 302 according to a second embodiment. FIG. 3c illustrates the application of the protective layer 302 through use of a vacuum, or pressure differential. A region of higher pressure 310 may be above the protective layer 302, and a region of lower pressure 312 may be below the protective layer 302. The difference in pressures of these two regions may apply 102 the protective layer 302 by pressing the protective layer 302 into position on the top side 304 of the wafer 200.

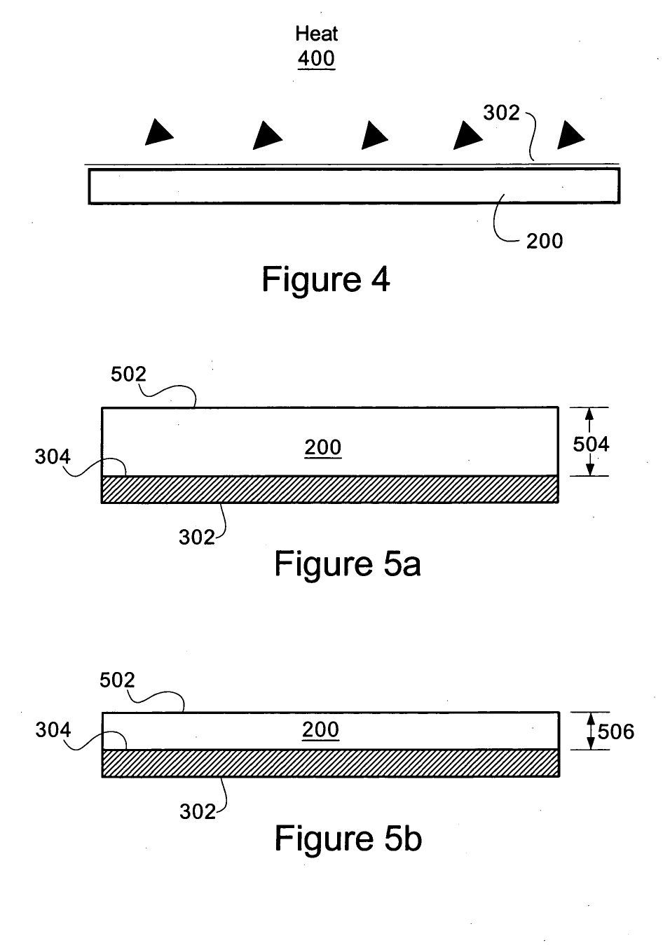

Returning to FIG. 1, the protective layer 302 may be partially cured 104 after it is applied 102 to the wafer 200 in one embodiment. Referring now to FIG. 4, a cross sectional side view of the wafer 200 and protective layer 302 is illustrated. In an embodiment, the protective layer 302 may comprise epoxy, and heat 400 may be applied to the protective layer 302 to partially cure the epoxy. In other embodiments, the epoxy may be partially cured with a different method. In yet other embodiments, the protective layer 302 may comprise other materials than epoxy and the protective layer 302 may be partially hardened with a process appropriate to the material used rather than partially cured. This partial curing 104, or other partial hardening process, may help the protective layer 302 to adhere to the wafer 200 during subsequent processing, and add structural rigidity to better protect the wafer 200 and any microelectronic circuits or devices on the chips 202 of the wafer 202 during subsequent processing.

Returning to FIG. 1, the wafer 200 may then be thinned 106. Referring now to FIG. 5a, a cross sectional side view of the wafer 200 and protective layer 302 is illustrated. The wafer 200 shown in FIG. 5a has been flipped upside down so that the top 304 side of the wafer 200 is toward the bottom of FIG. 5a, and the bottom side 502 of the wafer 200 is toward the top of FIG. 5a. The wafer 200 may have an initial thickness 504 after the microelectronic circuits or devices on the chips 202 of the wafer 200 have been fabricated. In an embodiment, the original thickness 504 may be in a range from 28 to 32 thousandths of an inch thick. In other embodiments, the wafer 200 may have a different initial thickness 504. Some of the material from the bottom 502 of the wafer 200 may be removed to reduce the thickness of the wafer 200 and result in a smaller thickness 506, as shown in FIG. 5b. In an embodiment, this smaller thickness 506 may be in a range of about 2 to 17 thousandths of an inch less than the initial thickness 504. In other embodiments, varying smaller thicknesses 506 may result from the thinning process. This smaller thickness 506 may be achieved by grinding away some of the material on the bottom 502 of the wafer 200. During such grinding, the protective layer 302 may protect from damage the top 304 of the wafer 200, any microelectronic circuits or devices on the chips 202 of the wafer 200, and the connection structures 308 connected to the top 304 of the wafer.

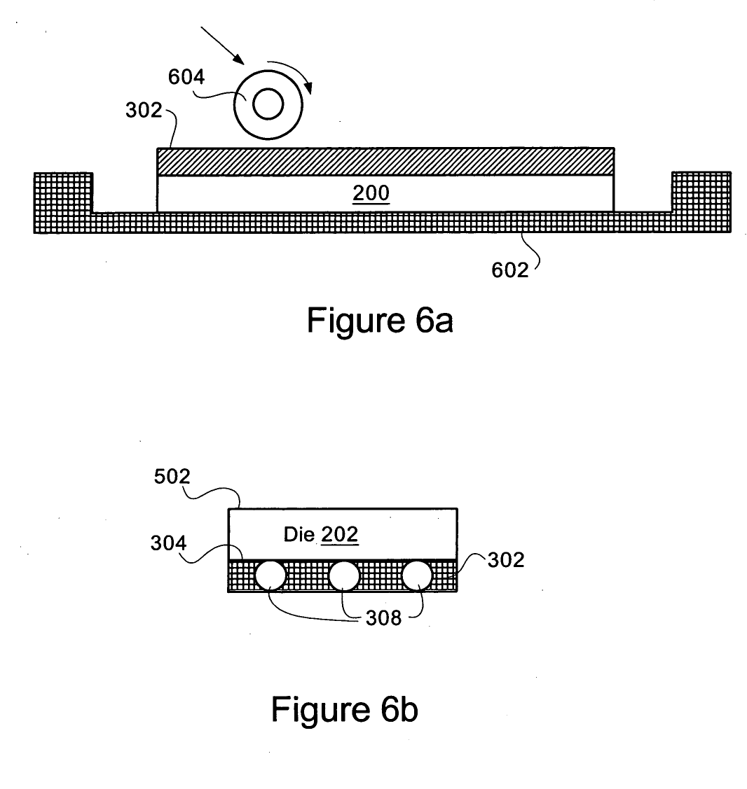

Returning to FIG. 1, the wafer 200 may be mounted 108 on a frame, which may hold the wafer 200 in position while the wafer 200 is cut to separate 110 the individual chips 202 from the wafer 200 and each other. Referring now to FIG. 6a, a cross sectional side view of the wafer 200 with the protective layer 302 mounted in a frame 602 and being cut to separate 110 the individual chips 202 from the wafer 200 and each other, also known as singulating the chips 202, is illustrated. A rotating saw blade 604 may be used to cut apart the wafer 200 into multiple chips 202 in one embodiment. During this cutting, the protective layer 302 may protect the chips 202, and any microelectronic circuits or devices on the chips 202, from being damaged during the cutting process, or from particulate matter created during the cutting process that could otherwise contaminate the microelectronic circuits or devices on the chips 202.

FIG. 6b is a cross sectional side view that illustrates one die 202 after it has been singulated from the wafer 200, according to one embodiment of the present invention. As illustrated, the bottom side 502 of the die 202 is toward the top of FIG. 6b, and the top 304 of the die 202, which may have microelectronic circuits or devices, is toward the bottom of FIG. 6b. A portion of the protective layer 302 that covers the die 202 has also been cut during the singulation process, so remains covering the die 202. The term “protective layer 302” may refer to both the layer 302 that covers the entire wafer 200 and the portion 302 of the layer that covers a single die 202 after singulation. The protective layer 302 may also cover connection structures 308 that are coupled to the die 302 in an embodiment. In one embodiment, the protective layer 302 may substantially cover the connection structures 308, but not extend substantially further from the top 304 of the die 202 than the point of the connection structures 308 that is farthest from the die 202. In another embodiment, the protection layer 302 may have a thickness larger than the height of the connection structures 308 so that the protection layer 302 extends farther from the top 304 of the die than the connection structures 308 do.

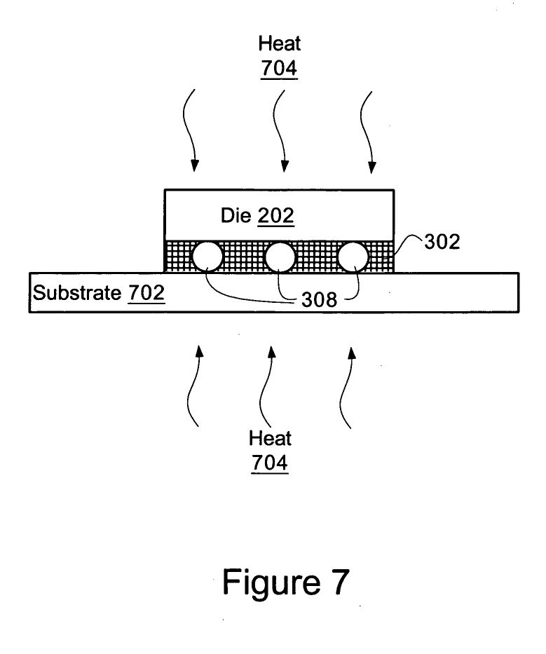

Returning to FIG. 1, the chip 202 may be positioned 112 on a substrate to which that chip 202 may be attached. The chip 202 may then be attached 114 or connected 114 to the substrate. The protective layer 302 may also be fully cured 114. Referring now to FIG. 7, a cross sectional side view of a die 202 positioned 112 adjacent to a substrate 702 and being attached 114 to the substrate 702 while the protective layer 302 is cured 114 according to one embodiment of the present invention, is illustrated. When positioning 112 the die 202 on the substrate 702, the connection structures 308 may be positioned so that they may both electrically and structurally connect the die 202 to the substrate 702. In an embodiment, since the protective layer 302 may have been only partially cured, the protective layer 302 may maintain some flexibility. This may allow the connection structures 308 to force any material of the protective layer 302 between the edge of the connection structure 308 and the substrate 702 out of the way while the die 202 is pressed to the substrate 702, to allow the connection structure 308 to contact the substrate 702 even if the protective layer 302 had extended beyond the connection structure 308 prior to positioning 112 the die 202 adjacent the substrate 702.

Heat 704 may be applied to the top or bottom of the die 202/substrate 702 assembly. In an embodiment where the connection structures 308 comprise solder, this heat 704 may cause some of the solder to melt, to reflow solder connect the die 202 to the substrate 702. This reflow soldering may thus attach 114 the die 202 to the substrate 702. In an embodiment where the protective layer 302 comprises epoxy, such as a heat curable epoxy, the heat 704 may also fully cure 114 the protective layer 302, which may then act as underfill between the die 202 and substrate 702. Thus, a portion of the protective layer 302 applied 102 to the wafer 200 may remain between the die 202 and substrate 702 after the die 202 has been singulated from the wafer 200 and attached to the substrate 702.

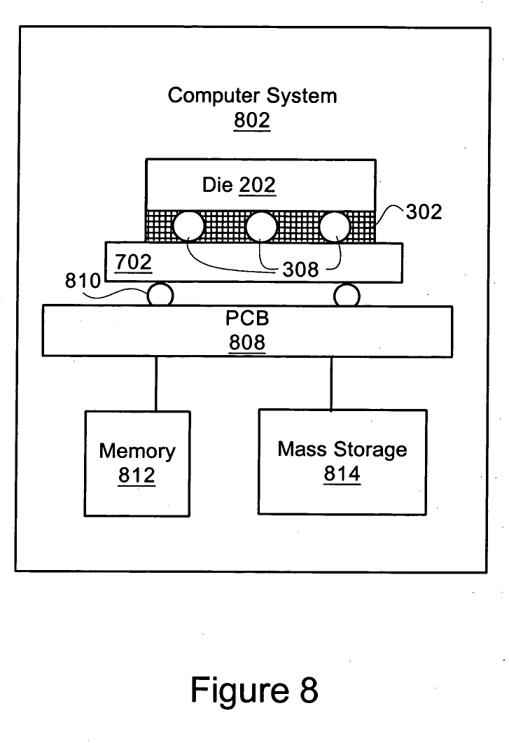

FIG. 8 is a schematic diagram of a computer system 802 according to one embodiment of the present invention. The computer system 802 may include the die 202 attached to the substrate 702, with the protective layer 302 between the die 202 and substrate 702, as described above. The substrate 702 may be connected to a structure such as a printed circuit board (“PCB”) 808 by connectors such as solder balls 810 or other connectors. Additionally, the computer system 802 may include a memory 812 and/or a mass storage unit 814, and/or other components which may be connected to the PCB 808. The memory 804 may be any memory, such as random access memory, read only memory, or other memories. The mass storage unit 814 may be a hard disk drive or other mass storage device. The computer system 802 may also include other components such as input/output units, a microprocessor, or other components.

The foregoing description of the embodiments of the invention has been presented for the purposes of illustration and description. It is not intended to be exhaustive or to limit the invention to the precise forms disclosed. This description and the claims following include terms, such as left, right, top, bottom, over, under, upper, lower, first, second, etc. that are used for descriptive purposes only and are not to be construed as limiting. The embodiments of a device or article described herein can be manufactured, used, or shipped in a number of positions and orientations. Persons skilled in the relevant art can appreciate that many modifications and variations are possible in light of the above teaching. Persons skilled in the art will recognize various equivalent combinations and substitutions for various components shown in the Figures. It is therefore intended that the scope of the invention be limited not by this detailed description, but rather by the claims appended hereto.

1. A method, comprising:
applying a protective layer to a first side of a wafer, the protective layer covering connection structures on the wafer;
removing, after applying the protective layer, material from a second side of the wafer to thin the wafer;
separating the wafer into a plurality of chips; and
attaching at least one of the chips to a substrate by connecting the connection structures to the substrate, wherein at least a portion of the protective layer remains between the chip and the substrate after attachment.

2. The method of claim 1, wherein the protective layer comprises epoxy.

3. The method of claim 2, further comprising partially curing the epoxy after application of the protective layer and prior to removing material from the second side of the wafer.

4. The method of claim 1, wherein the connection structures comprise solder balls.

5. The method of claim 4, wherein attaching at least one of the chips to the substrate comprises applying heat to at least partially melt the solder balls to reflow solder the chip to the substrate.

6. The method of claim 5, wherein the protective layer comprises epoxy, further comprising partially curing the epoxy after application of the protective layer and prior to removing material from the second side of the wafer.

7. The method of claim 6, wherein applying heat to at least partially melt the solder balls also finishes curing the epoxy.

8. The method of claim 1, further comprising, at substantially the same time as separating the wafer into a plurality of chips, separating the protective layer to a plurality of sections, each of the sections remaining in contact with one of the plurality of chips.

9. A method, comprising:
applying a protective layer to a first side of a wafer comprising at least one integrated circuit die, the protective layer covering connection structures on the wafer adjacent to the at least one integrated circuit die;
removing, after applying the protective layer, material from a second side of the wafer to thin the wafer; and
separating, after removing material from the second side of the wafer, the at least one integrated circuit die from the wafer without first removing the protective layer.

10. The method of claim 9, wherein the protective layer comprises a protective film comprising epoxy.

11. The method of claim 9, further comprising, at substantially the same time as separating the at least one integrated circuit die from the wafer, separating the protective layer to a plurality of sections, one of the sections remaining in contact with the at least one integrated circuit die.

12. The method of claim 9, further comprising attaching the at least one integrated circuit die separated from the wafer to a substrate by connecting the connection structures to the substrate, wherein at least a portion of the protective layer remains between the at least one integrated circuit die and the substrate after attachment.

13. A method, comprising:
applying a protective layer to a first side of a wafer, the protective layer covering connection structures on the wafer;
separating the wafer into a plurality of chips; and
attaching at least one of the chips separated from the wafer to a substrate by connecting the connection structures to the substrate, wherein at least a portion of the protective layer remains between the chip and the substrate after attachment.

14. The method of claim 13, wherein the protective layer comprises epoxy.

15. The method of claim 13, wherein the connection structures comprise solder balls.

16. The method of claim 15, wherein attaching at least one of the chips to the substrate comprises applying heat to at least partially melt the solder balls to reflow solder the chip to the substrate.

17. The method of claim 16, further comprising removing, after applying the protective layer, material from a second side of the wafer to thin the wafer, wherein the protective layer comprises epoxy, further comprising partially curing the epoxy after application of the protective layer and prior to removing material from the second side of the wafer.

18. A method, comprising:
applying a protective layer comprising epoxy to a first side of a wafer, the wafer comprising at least one integrated circuit die at the first side of the wafer, to protect solder balls on the first side of the wafer adjacent to the at least one integrated circuit die;
partially curing the epoxy in the protective layer;
removing, after applying and partially curing the protective layer, material from a second side of the wafer;
separating the at least one integrated circuit die from the wafer;
positioning the separated integrated circuit die on a substrate; and
heating the at least one integrated circuit die and the protective layer to attach the at least one integrated circuit die to the substrate and to cure the protective layer.

19. The method of claim 18, further comprising coupling the substrate to a circuit board, wherein at least a portion of the protective layer remains between the integrated circuit die and the substrate after the substrate is coupled to the circuit board.

20. A device, comprising:
a die with a first side and a second side;
a substrate with a first side and a second side;
at least one connection structure connected to the first side of the die and to the first side of the substrate to couple the die to the substrate; and
a protective layer between the first side of the die and the first side of the substrate, the protective layer having been applied to the die prior to the die being singulated from a wafer comprising a plurality of dies.

21. The method of claim 20, the protective layer having been applied to the die prior to the wafer being thinned.

22. The device of claim 20, further comprising a printed circuit board coupled to the substrate and memory coupled to the printed circuit board.
